(19) United States
(12) Patent Application Publication
(10) Pub. No.: US 2023/0055581 A1
(43) Pub. Date: Feb. 23, 2023

(54) PRIVACY PRESERVING ANOMALY DETECTION USING SEMANTIC SEGMENTATION

(71) Applicant: Milestone Systems A/S, Brøndby (DK)

(72) Inventors: Michael BIDSTRUP, Aalborg (DK); Jacob Velling DUEHOLM, Aalborg (DK); Kamal NASROLLAHI, Brøndby (DK)

(21) Appl. No.: 17/498,537

(22) Filed: Oct. 11, 2021

(30) Foreign Application Priority Data
Aug. 12, 2021 (GB) 2111600.9

(51) Int. Cl. G06K 9/00; G06T 7/11; H04N 7/18; G06T 7/12; H04N 5/272; G06K 9/36; G06F 21/62; G06N 3/04

(52) U.S. Cl. CPC G06K 9/00771; G06T 7/11; G06K 9/00718; H04N 7/181; H04N 7/183; G06T 7/12; H04N 5/272; G06K 9/36; G06F 21/6254; G06N 3/0454; G06T 2207/30232; G06T 2207/10016; G06T 2207/20084; G06K 2009/00738

(57) ABSTRACT

A computer implemented method of anonymising video surveillance data of a scene and detecting an object or event of interest in such anonymised video surveillance data, the method comprising segmenting frames of video surveillance data of at least one scene into corresponding frames of segmented data using image segmentation, wherein a mask label is assigned to every pixel of each frame of the segmented data based either on a class of objects or of surfaces or on an instance of such a class that pixel belongs to, and detecting at least one object and/or event of interest based on at least one shape and/or motion in at least one frame of the segmented data.

### CROSS-REFERENCE TO RELATED APPLICATIONS

This application claims the benefit under 35 U.S.C. § 119(a)-(d) of United Kingdom Patent Application No. 2111600.9, filed on Aug. 12, 2021 and titled “Privacy Preserving Anomaly Detection using Semantic Segmentation”. The above cited patent application is incorporated herein by reference in its entirety.

### TECHNICAL FIELD OF THE DISCLOSURE

The present disclosure relates to a video processing apparatus, a video surveillance system, a computer implemented method for anonymising video surveillance data of a scene and detecting an object or event of interest in such anonymised video surveillance data.

### BACKGROUND OF THE DISCLOSURE

Surveillance systems are typically arranged to monitor surveillance data received from a plurality of data capture devices. A viewer may be overwhelmed by large quantities of data captured by a plurality of cameras. If the viewer is presented with video data from all of the cameras, then the viewer will not know which of the cameras requires the most attention. Conversely, if the viewer is presented with video data from only one of the cameras, then the viewer may miss an event that is observed by another of the cameras.

An assessment needs to be made of how to allocate resources so that that the most important surveillance data is viewed or recorded. For video data that is presented live, presenting the most important information assists the viewer in deciding actions that need to be taken, at the most appropriate time. For video data that is recorded, storing and retrieving the most important information assists the viewer in understanding events that have previously occurred. Providing an alert to identify important information ensures that the viewer is provided with the appropriate context in order to assess whether captured surveillance data requires further attention.

The identification of whether information is important is typically made by the viewer, although the viewer can be assisted by the alert identifying that the information could be important. Typically, the viewer is interested to view video data that depicts the motion of objects that are of particular interest, such as people or vehicles.

There is a need for detected motion to be given priority if it is identified as being more important than other motion that has been detected. It is useful to provide an alert to the viewer so that they can immediately understand the context of the event, so that an assessment can be made of whether further details are required. This is achieved by generating an alert that includes an indication of the moving object or the type of motion detected.

With the increasing importance of the video surveillance market, arise both new technologies for improving the efficiency of surveillance and privacy concerns about the use of it. In particular, people may not consent to being videotaped if they are identifiable on video, and such recording may be prohibited or restricted by law if people are identifiable on video.

This applies both to public surveillance and surveillance in institutions such as hospitals and nursery homes.

A solution to these concerns was presented by

J. Yan, F. Angelini and S. M. Naqvi at ICASSP 2020 in Barcelona: “Image Segmentation Based Privacy-Preserving Human Action Recognition for Anomaly Detection”, https://sigport.org/documents/image-segmentation-based-privacy-preserving-human-action-recognition-anomaly-detection#files.

The solution presented in this presentation relies on Mask-RCNN, which is a state-of-the-art framework or model for carrying out object instance segmentation, described in K. He, G. Gkioxari, P. Dollar and R. Girshick, “Mask R-CNN,” 2017 IEEE International Conference on Computer Vision (ICCV), 2017, pp. 2980-2988, doi: 10.1109/ICCV.2017.322. The Mask-RCNN framework carries out bounding-box object detection and applies a mask to pixels which belong to an object detected within a bounding box.

More particularly, the presentation describes using the Mask-RCNN framework to occlude human targets present in a foreground of a video, while preserving background data of the video, by occluding these human targets with a black mask. Human Action Recognition (HAR) is then performed on the segmented data obtained from the Mask-RCNN framework with near-similar results in comparison with original, non-masked, RGB video data.

However, there are drawbacks to this approach that can lead to a failure to achieve the objective of privacy protection. First, because this presentation is only interested in human targets, it does not consider masking objects belonging to human targets, which could reveal the identity of a human. For instance, a car with a particular licence plate, a bicycle with a particular shape as seen in the former presentation, a suitcase with a luggage tag attached to it or paper documents on a table could all reveal the identity of a human. More generally, the presentation doesn't consider masking a background in the video, even though such a background could include personal or otherwise confidential information. Second, because the Mask-RCNN framework uses bounding-box detection prior to carrying out masking of a human target, there may be instances where the framework fails to detect a human target for many seconds, during which the viewer will have the opportunity to see the person who is eventually masked. Indeed, bounding-box detection systems never operate instantaneously and can be slowed down by changes in light conditions in the scene, unusual postures assumed by human targets, or even be confused by accessories worn by human targets. More generally, these systems operate on the basis of a probabilistic approach and may not detect certain targets. Third, even though the presentation suggests assessing the potential of the Mask-RCNN framework with systems other than HAR (e.g. anomaly detection (AD) systems), it doesn't suggest using any other detection and masking framework than the Mask-RCNN framework.

Anomaly detection, also referred to as abnormal event detection or outlier detection, is the identification of rare events in data. When applied to computer vision this concerns the detection of abnormal behaviour in amongst other things people, crowds and traffic. With the ability to automatically determine if footage is relevant or irrelevant through anomaly detection, this amount of footage could be greatly reduced and could potentially allow for live investigation of the surveillance. This could result in emergency personal receiving notice of a traffic accident before it is called in by bystanders, care takers to know if an elderly has fallen down or police to be aware of an escalating situation requiring their intercession. However, anomaly detection has so far failed to address the need for privacy or anonymity.

Thus, there is a general need to detect objects or events of interest (including rare and/or abnormal events) in scenes and to meet the need for more privacy-friendly video surveillance systems.

### SUMMARY OF THE DISCLOSURE

The present disclosure addresses at least some of the above-mentioned issues.

According to a first aspect of the present disclosure, there is provided a computer implemented method of anonymising video surveillance data of a scene and detecting an object or event of interest in such anonymised video surveillance data, the method comprising: segmenting frames of video surveillance data of at least one scene into corresponding frames of segmented data using image segmentation, wherein a mask label is assigned to every pixel of each frame of the segmented data based either on a class of objects or of surfaces or on an instance of such a class that pixel belongs to; and detecting at least one object and/or event of interest based on at least one shape and/or motion in at least one frame of the segmented data.

Optionally, in the method according to the present disclosure, segmenting frames of video surveillance data comprises carrying out semantic segmentation of the said video surveillance data.

Optionally, in the method according to the present disclosure, segmenting frames of video surveillance data comprises carrying out image segmentation with a first artificial neural network. Advantageously, the said first neural network has been pre-trained using supervised learning.

Optionally, the method according to the present disclosure further comprises determining a user's right to view the video surveillance data, the segmented data and/or at least a part thereof, and displaying to the user the video surveillance data, the segmented data and/or at least a part thereof, based on that determination.

Optionally, in the method according to the present disclosure, each segmented frame comprises all segments obtained from a corresponding frame of the video surveillance data.

Optionally, the method according to the present disclosure further comprises acquiring the video surveillance data from at least one physical video camera, and wherein segmenting the video surveillance data comprises segmenting the video surveillance data within the physical video camera.

Optionally, in the method according to the present disclosure, the video surveillance data comprises video surveillance data of different scenes from a plurality of physical video cameras.

Optionally, the method according to the present disclosure further comprises storing in a recording server the said at least one frame of segmented data based on which the said object or event of interest has been detected. Advantageously, the method according to the present disclosure further comprises storing in the recording server all of the segmented data.

Optionally, in the method according to the present disclosure, each segment substantially traces the contour of one or more objects or surfaces represented by that segment.

Optionally, in the method according to the present disclosure, each segment is represented as a colour.

Optionally, the method according to the present disclosure further comprises generating a composite video and/or image of the video surveillance data on which at least one segment is represented, and providing anonymity to an object or surface in the video surveillance data by masking that object or surface with that segment.

Optionally, the method according to the present disclosure further comprises enhancing at least part of at least one segment based on a predetermined change between two or more frames in the video surveillance data, such that detecting the said at least one object or event of interest is facilitated.

Advantageously, the said predetermined change comprises a change in an appearance or motion of the said at least one object between the said two or more frames. Additionally and/or alternatively, the said predetermined change comprises a change in a relationship between the said at least one object and at least one other object in the said two or more frames.

Optionally, in the method according to the present disclosure, detecting at least one object or event of interest comprises carrying out anomaly detection.

Optionally, in the method according to the present disclosure, detecting at least one object or event of interest comprises carrying out detection with a second artificial neural network. Advantageously, the said second neural network has been pre-trained using unsupervised learning to detect objects and/or events of interest.

Optionally, in the method according to the present disclosure, the objects in the said class of objects are chosen from a group consisting of people and vehicles.

According to a second aspect of the present disclosure, there is provided a video processing apparatus, comprising at least one processor configured to: segment frames of video surveillance data of at least one scene into corresponding frames of segmented data using image segmentation, wherein a mask label is assigned to every pixel of each frame of the segmented data based either on a class of objects or of surfaces or on an instance of such a class that pixel belongs to; and configured to detect at least one object and/or event of interest based on at least one shape and/or motion in at least one frame of the segmented data.

Optionally, in the video processing apparatus according to the present disclosure, the said at least one processor is configured to segment the video surveillance data by carrying out semantic segmentation of the said video surveillance data. Advantageously, in the video processing apparatus according to the present disclosure, detecting at least one object or event of interest comprises carrying out anomaly detection.

According to a third aspect of the present disclosure, there is provided a video surveillance system comprising a video processing apparatus according to any one of the above-mentioned definitions and a client apparatus comprising a display, the client apparatus comprising at least one processor configured to determine a user's right to view the video surveillance data, the segmented data and/or at least a part thereof, the at least one processor of the client apparatus being further configured to display to the user the video surveillance data, the segmented data and/or at least a part thereof, based on that determination.

Aspects of the present disclosure are set out by the independent claims and preferred features of the present disclosure are set out in the dependent claims.

In particular, the present disclosure achieves the aim of anonymising surveillance while maintaining the ability to detect objects and/or events of interest by segmenting frames of video surveillance data into corresponding frames of segmented data using image segmentation. According to the present disclosure, a mask label is assigned to every pixel of each frame of the segmented data based either on (i) a class of objects or of surfaces (in or across the scene) or on (ii) an instance of such a class that pixel belongs to. Since all pixels are assigned with a mask label, the detection and masking systems neither depend on a prior detection of a target by a fallible bounding-box detection system nor on a correct application of a mask within a bounding-box.

Thus, the image segmentation carried out in the present disclosure relies on a segmentation model which doesn't use any bounding boxes.

Additional features of the present disclosure will become apparent from the following description of embodiments with reference to the attached drawings.

### BRIEF DESCRIPTION OF THE DRAWINGS

Embodiments of the present disclosure will now be described, by way of example only, with reference to the accompanying drawings in which:

FIG. 1 shows a video surveillance system in which the present disclosure can be implemented;

FIG. 2 is a flowchart illustrating the steps of the computer implemented method of anonymising video surveillance data of a scene and detecting an object or event of interest in such anonymised video surveillance data.

FIGS. 3a/3b illustrate an image before and after semantic segmentation.

### DETAILED DESCRIPTION OF THE DISCLOSURE

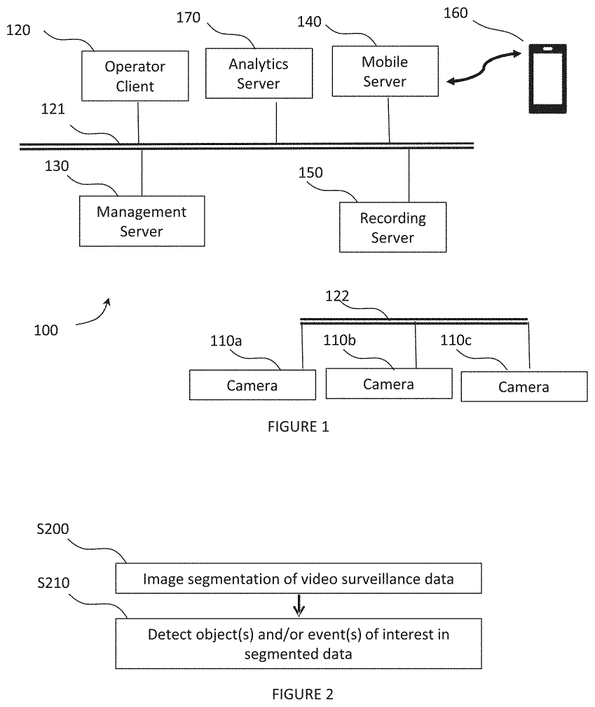

FIG. 1 shows an example of a video surveillance system 100 in which embodiments of the present disclosure can be implemented. The system 100 comprises a management server 130, a recording server 150, an analytics server 170 and a mobile server 140, which collectively may be referred to as a video management system. Further servers may also be included in the video management system, such as further recording servers or archive servers. A plurality of video surveillance cameras 110a, 110b, 110c send video surveillance data to the recording server 150. An operator client 120 is a fixed terminal which provides an interface via which an operator can view video data live from the cameras 110a, 110b, 110c, and/or recorded video data from the recording server 150.

The cameras 110a, 110b, 110c capture image data and send this to the recording server 150 as a plurality of video data streams.

The recording server 150 stores the video data streams captured by the video cameras 110a, 110b, 110c. Video data is streamed from the recording server 150 to the operator client 120 depending on which live streams or recorded streams are selected by an operator to be viewed.

The mobile server 140 communicates with a user device 160 which is a mobile device such as a smartphone or tablet which has a touch screen display. The user device 160 can access the system from a browser using a web client or a mobile client. Via the user device 160 and the mobile server 140, a user can view recorded video data stored on the recording server 150. The user can also view a live feed via the user device 160.

The analytics server 170 can run analytics software for image analysis, for example motion or object detection, facial recognition, event detection. The analytics server 170 may generate metadata which is added to the video data and which describes objects which are identified in the video data.

Other servers may also be present in the system 100. For example, an archiving server (not illustrated) may be provided for archiving older data stored in the recording server 150 which does not need to be immediately accessible from the recording server 150, but which it is not desired to be deleted permanently. A fail-over recording server (not illustrated) may be provided in case a main recording server fails.

The operator client 120, the analytics server 170 and the mobile server 140 are configured to communicate via a first network/bus 121 with the management server 130 and the recording server 150. The recording server 150 communicates with the cameras 110a, 110b, 110c via a second network/bus 122.

The management server 130 includes video management software (VMS) for managing information regarding the configuration of the surveillance/monitoring system 100 such as conditions for alarms, details of attached peripheral devices (hardware), which data streams are recorded in which recording server, etc.. The management server 130 also manages user information such as operator permissions. When an operator client 120 is connected to the system, or a user logs in, the management server 130 determines if the user is authorised to view video data. The management server 130 also initiates an initialisation or set-up procedure during which the management server 130 sends configuration data to the operator client 120. The configuration data defines the cameras in the system, and which recording server (if there are multiple recording servers) each camera is connected to. The operator client 120 then stores the configuration data in a cache. The configuration data comprises the information necessary for the operator client 120 to identify cameras and obtain data from cameras and/or recording servers.

Object detection/recognition can be applied to the video data by object detection/recognition software running on the analytics server 170. The object detection/recognition software preferably generates metadata which is associated with the video stream and defines where in a frame an object has been detected. The metadata may also define what type of object has been detected e.g. person, car, dog, bicycle, and/or characteristics of the object (e.g. colour, speed of movement etc). Other types of video analytics software can also generate metadata, such as licence plate recognition, or facial recognition.

Object detection/recognition software, may be run on the analytics server 170, but some cameras can also carry out object detection/recognition and generate metadata, which is included in the stream of video surveillance data sent to the recording server 150. Therefore, metadata from video analytics can be generated in the camera, in the analytics server 170 or both. It is not essential to the present disclosure where the metadata is generated. The metadata may be stored in the recording server 150 with the video data, and transferred to the operator client 120 with or without its associated video data.

The video surveillance system of FIG. 1 is an example of a system in which the present disclosure can be implemented. However, other architectures are possible. For example, the system of FIG. 1 is an “on premises” system, but the present disclosure can also be implemented in a cloud based system. In a cloud based system, the cameras stream data to the cloud, and at least the recording server 150 is in the cloud. Video analytics may be carried out at the camera, and/or in the cloud. The operator client 120 or mobile client 160 requests the video data to be viewed by the user from the cloud.

A search facility of the operator client 120 may allow a user to look for a specific object or combination of object by searching metadata. Metadata generated by video analytics such as object detection/recognition discussed above can allow a user to search for specific objects or combinations of objects (e.g. white van or man wearing a red baseball cap, or a red car and a bus in the same frame, or a particular license plate or face). The operator client 120 or the mobile client 160 will receive user input of at least one search criterion, and generate a search query.

A search can then be carried out for metadata matching the search query. The search software then sends a request to extract image data from the recording server 150 corresponding to portions of the video data having metadata matching the search query, based on the timestamp of the video data. This extracted image data is then received by the operator client 120 or mobile client 160 and presented to the user at the operator client 120 or mobile client 160 as search results, typically in the form of a plurality of thumbnail images, wherein the user can click on each thumbnail image to view a video clip that includes the object or activity.

FIG. 2 is a flowchart illustrating the steps of the computer implemented method of anonymising video surveillance data of a scene and detecting an object or event of interest in such anonymised video surveillance data, according to the present disclosure.

In a step S200, frames of video surveillance data of a scene are segmented into corresponding frames of segmented data using image segmentation, wherein a mask label is assigned to every pixel of each frame of the segmented data based either on a class of objects or of surfaces or on an instance of such a class that pixel belongs to.

Image segmentation can be carried out using, for instance, panoptic segmentation or preferably semantic segmentation, providing that a mask label is assigned to every pixel of each frame of the segmented data based either on a class of objects or of surfaces that pixel belongs to (with semantic segmentation) or on an instance of such a class that pixel belongs to (with panoptic segmentation). With panoptic segmentation, different objects and/or surfaces will be depicted as different segments, while with semantic segmentation, different instances of the same class (or category) of objects or of surfaces will be depicted as the same segment. Thus, semantic segmentation may be preferable in cases where there is a need to depict all instances of the same class under the same segment, for instance to further strengthen the protection of the privacy of individuals.

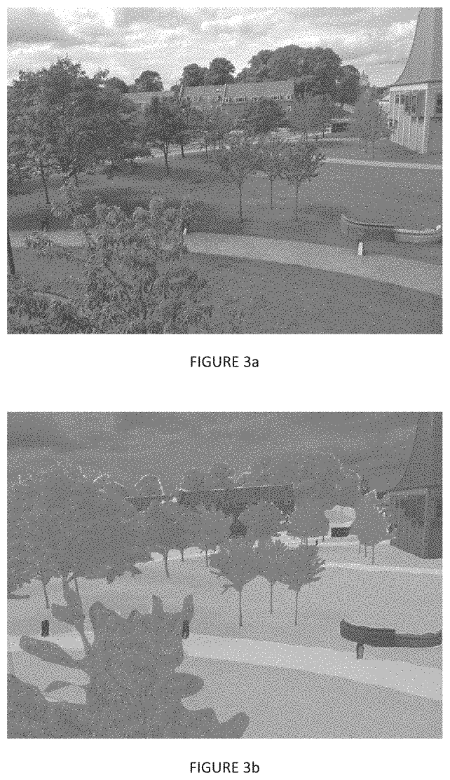

FIG. 3a illustrates an image of a park with buildings in the background, lawns separated by several footpaths, trees on the different lawns and blocks and posts at the edge of the footpaths in the foreground and background.

FIG. 3b illustrates the same image on which semantic segmentation has been carried out. As can be seen, objects and surfaces are categorised and all objects in the same class are coloured in the same colour (or in the same shade). Although the photo in FIG. 3b shows some details of the trees, buildings, etc., it is entirely possible to increase the opacity of the masks to further enhance privacy.

On the other end, with panoptic segmentation, each instance of a tree, building, etc., would have been assigned a single label mask, i.e. would have been coloured with a single colour (or shade). This would have made it possible to better distinguish different instances within each class but would have reduced privacy.

Image segmentation may be carried out by the (physical) video surveillance cameras. It thus becomes possible to avoid transferring the original RGB data outside of the video cameras, thereby increasing the privacy of the RGB data. Alternatively, it is possible to carry out the image segmentation on a server or video processing apparatus, for instance when the video cameras do not have the necessary hardware to carry out image segmentation. Image segmentation may also be carried out by the VMS.

Different segmentation models may be used. For instance different pre-trained, semantic segmentation models (artificial neural networks (ANNs)) may be used. These ANNs e.g. DeepLab, FCN, EncNet, DANet or Dranet, are further configured with a backbone e.g. ResNeSt50, ResNet50 or ResNet101 and with a training dataset e.g. ADE20K or Cityscapes, known to the skilled person. Each ANN is preferably trained using supervised learning, meaning the training videos for these ANNs are labelled with different objects and/or surfaces to be detected. To compare these different models, both a quantitative and qualitative analysis can be performed. The quantitative analysis consists in identifying each model's ability to segment the objects of interest in the scene. The qualitative comparison of the performance may be done by comparing standard evaluation metrics, such as for instance for semantic segmentation models, pixel accuracy (PixAcc) and mean intersection over union (mIoU). In the quantitative comparison of the segmentation models, each frame is compared in respect to the classes detected in the scene and by the amount of noise present on surfaces.

It is further possible to test and compare these different pre-trained semantic segmentation models by segmenting a dataset (corresponding to video surveillance data) comprising anomaly annotations. For instance the Avenue dataset developed by the University of China, Hong Kong, may be used. To ensure the comparison covers important anomalous scenarios, six frames from the test set are used based on objects and motions in the scene. The first frame is an empty frame, used to create a baseline for the segmentation of the background. The second frame is full of people with a commuter walking in the wrong direction. The third frame is of a person running, to test the model's ability to segment blurred objects in motion. The final three frames contain anomalous events with objects such as a bag and papers being thrown and a person walking with a bike. Comparing every frame in the subset shows some general features of every model. In general, models trained on ADE20K contain more noise than those trained on Cityscapes. Furthermore, models trained with ResNeSt as backbone are less capable of detecting the exact structure of the building in the background. The below table shows each model's overall ability to segment the classes of interest throughout the comparison:

| Model & | Objects and surfaces | | | | | | | |
|---|---|---|---|---|---|---|---|---|
| backbone | People | Ground | Grass | Building | Background | Bag | Papers | Bike |
| DeepLab & | ✓ | ✓ | ✓ | | ✓ | | | ✓ |
| ResNeSt50 | | | | | | | | |
| FCN & | ✓ | ✓ | ✓ | | | | | |
| ResNet50s | | | | | | | | |
| FCN & | ✓ | ✓ | ✓ | ✓ | ✓ | | | ✓ |
| ResNeSt50 | | | | | | | | |
| EncNet & | ✓ | ✓ | | ✓ | | | | ✓ |
| ResNet50s | | | | | | | | |
| EncNet & | ✓ | ✓ | ✓ | ✓ | | | | |
| ResNet101s | | | | | | | | |
| DANet & | ✓ | ✓ | ✓ | ✓ | ✓ | ✓ | | ✓ |
| ResNet101 | | | | | | | | |
| Dranet & | ✓ | ✓ | | ✓ | ✓ | ✓ | | ✓ |
| Resnet101 | | | | | | | | |

According to the present disclosure, a mask label is assigned to every pixel of each frame of the segmented data based either on a class of objects or of surfaces that pixel belongs to or on an instance of such a class that pixel belongs to.

Accordingly, objects or surfaces which are not properly detected (e.g. ‘papers’, as shown in the above table) are treated as background data and can for instance be included in a generic background class or added to any one of the background sub-classes (e.g. a ‘structure’ class representing all beams and pillars of a building or a ‘walls’ class representing all walls of a building). These objects or surfaces may later be reclassified upon proper identification of their characteristics.

The segments thus trace the contour (silhouettes or perimeters) of the objects or surfaces they represent. For instance, a segment representing a car will also have the shape of car. A segment representing several overlapping cars in the scene will however trace a contour encompassing all of these cars, as if they were a single entity.

According to the present disclosure, the segments may be represented as colours. With panoptic segmentation, each instance of an object (e.g. each car) or surface (e.g. each part of a building) may be represented by a single colour. However, with semantic segmentation, all instances of a class of objects (e.g. all cars in the scene) or of surfaces (e.g. all parts of a building) may be represented by a single colour. These colours allow a user or an operator to quickly derive the context of a scene. However, the different instances or segments may also be represented with the same colour but with different patterns(e.g. stripes, waves or the like).

Since vehicles and humans generate a wide variety of events that may be of interest from a surveillance perspective, it is particularly relevant to train the segmentation model to detect them.

Semantic segmentation systems can be evaluated on two metrics: Pixel accuracy (PixAcc) and mean intersection over union (mIoU). Pixel accuracy is a comparison of each pixel with the ground truth classification computed for each class as:

PixAcc=(TP+TN)/(TP+TN+FP+FN) (1)

### Where:

TP (true positive)=Class pixels correctly classified;
TN (true negative)=Non-class pixels correctly classified as not in the class;
FP (False positive)=Class pixels incorrectly classified;
FN (False negative)=Non-class pixels incorrectly classified.

When a ratio of correctness for each class has been computed they are averaged over the set of classes. A problem with PixAcc is that classes with a small amount of pixels achieve high pixel accuracy from the true negative being high. In other words, as true negative approaches infinity pixAcc approaches 1.

To avoid this problem, mIoU computes the accuracy of each class as the relationship between the intersection with other classes over the union of the classes (IoU):

IoU=area of overlap/area of union (2)

Or in other terms:

IoU=TP/(TP+FP+FN) (3)

before averaging over the amount of classes. This removes the true negatives from the equation and solves the above-mentioned problem with PixAcc.

To compute the PixAcc and mIoU of the segmentation models, the six frames can be manually annotated using the known ‘LabelMe’ annotation tool and interface created by the MIT Computer Science and Artificial Intelligence Laboratory (CSAIL).

It should be noted that a consistent classification of the objects in Avenue is more important than a correct classification as the specific class predictions can be neglected for the context they provide to the scene. This means the annotations are matched with the predictions for each model and surfaces with multiple predictions are determined by the most present class. Consequently, models with noise in the form of multiple classifications on surfaces achieve a lesser accuracy.

As the anomalies or events of interest are, in this example, performed by the people in the scene, each model is also compared based only on the precision of the segmentation of the people. The following pixAcc and mIoU results were obtained when using segmentation models on people in the frames of Avenue, after training the models with the training datasets ADE20k and Cityscapes:

| Model & backbone | Dataset | PixAcc | mIoU |
|---|---|---|---|
| FCN & ResNet50s | ADE20k | 96.49% | 84.39% |
| DeepLab & ResNest50 | ADE20k | 96.91% | 84.95% |
| EncNet & ResNet101 | ADE20k | 96.71% | 85.81% |
| DANet & ResNet101 | Cityscapes | 97.21% | 87.13% |
| Dranet & ResNet101 | Cityscapes | 97.01% | 86.52% |

These results demonstrate that semantic segmentation on people can efficiently be carried out with different segmentation models after training with different datasets.

Then, in a step S210 shown in FIG. 2, at least one object and/or event of interest is detected based on at least one shape and/or motion in at least one frame of the segmented data. This can be done by conventional HAR and/or AD systems using ANNs. AD systems that can be used include Conv-AE, Future Frame Prediction, MNAD_recon and MNAD_preds. According to the present disclosure, the step S210 preferably comprises (or alternatively consists in) AD detection, which has a wider scope than HAR as it is not limited to people. The ANNs are preferably trained using un-supervised learning, meaning the training videos for these networks are normal and do not include anomalies. However, the models can also be trained using supervised learning, where the training videos are labelled with normal and abnormal events.

Furthermore, similarly to the segmentation experiments, it is possible to evaluate the efficiency of the detection results, using different metrics. For instance, using a receiver operating characteristics (ROC) curve, which is a two-dimensional measure of classification performance in a binary classifier. It maps the true positive rate (TPR), also denoted as the sensitivity of the system on the y-axis against the false positive rate (FPR), denoted (1-specificity) on the x-axis. TPR and FPR are computed following:

TPR=TP/(TP+TN) and FPR=(FP/FP+FN) (4)

An ROC curve following the diagonal line y=x, called the reference line, produce true positive results at the same rate as false positive results. It follows that the goal of a system is to produce as many true positives as possible, resulting in an ROC curve in the upper left triangle of the graph, as described in Hoo Z H, Candlish J, Teare D. What is an ROC curve? Emerg Med J. 2017 June; 34(6):357-359. doi: 10.1136/emermed-2017-206735. Epub 2017 Mar. 16. PMID: 28302644. Here, a threshold can be decided based on the importance of capturing every true positive at the cost of more false positives. Finding the optimal cut-out threshold for classification is done by computing the TPR and FPR of different threshold values. The resolution used for the thresholds in this evaluation is dependent on the number of unique predictions in the data. To obtain a global measure of a system's classification performance, the area under the curve (AUC) is used. AUC represents the percentage of true positives in relation to the number of samples in ROC. An AUC of 1.0 represents perfect discrimination in the test with every positive being true positive and every negative being true negative. An AUC of 0.5 represents no discriminating ability with classifications being no better than chance.

For instance, an AUC of 85% was obtained for original RGB data with Future Frame Prediction, and an AUC of 75% was obtained for the segmented data with Future Frame Prediction.

It is further possible to determine performance results of these HAR and AD systems on specific objects and/or surfaces. For instance, regarding AD detection, each anomaly is annotated to test which anomalies the system is able and unable to detect. A comparison of the TPR and TNR for each anomaly for RGB and segmented data is provided in the table below:

| | | | | | | Kids | Camera | |
|---|---|---|---|---|---|---|---|---|
| | Running | Direction | Papers | Bag | Close | playing | shake | Total |
| Videos | 1-4 | 9-11, | 13, 14, | 5, 6, | 1, 6, 19 | 7-9, 17, | 2 | All |
| | | 13-16, 20 | 20 | 9-12 | | 18, 21 | | |
| Abnormal | 9 | 10 | 3 | 12 | 4 | 8 | 1 | 47 |
| events | | | | | | | | |
| Abnormal | 377 | 456 | 187 | 1154 | 743 | 854 | 49 | 3820 |
| frames | | | | | | | | |

RGB data

| | | | | | | | | |
|---|---|---|---|---|---|---|---|---|
| Detected | 9/9 | 10/10 | 3/3 | 12/12 | 4/4 | 8/8 | 1/1 | 47/47 |
| events | | | | | | | | |
| TRUE | 258 | 281 | 184 | 1045 | 632 | 600 | 25 | 3025 |
| positive | | | | | | | | |
| FALSE | 119 | 175 | 3 | 109 | 111 | 254 | 24 | 795 |
| negative | | | | | | | | |
| RGB TRP | 0.6844 | 0.6162 | 0.984 | 0.9055 | 0.8506 | 0.7026 | 0.5102 | 0.7918 |

Segmented data

| | | | | | | | | |
|---|---|---|---|---|---|---|---|---|
| Detected | 9/9 | 10/10 | 3/3 | 12/12 | 4/4 | 8/8 | 1 | 47/47 |
| events | | | | | | | | |
| TRUE | 293 | 252 | 137 | 823 | 416 | 622 | 28 | 2571 |
| positive | | | | | | | | |
| SS TRP | 0.7771 | 0.5526 | 0.7326 | 0.7132 | 0.5599 | 0.7283 | 0.5714 | 0.673 |

From the above table it can be seen that the RGB model achieves a true positive rate of 79.18% and the segmented model achieves a true positive rate of 67.30% on Avenue. However, it can also be seen that the AD model performs better on the segmented data than on the original RGB data for certain classes of objects, i.e. ‘Kids playing’ and ‘Camera shake’. Thus, segmenting the video surveillance data and assigning a label mask to every pixel may actually improve performance of the AD detection systems for some classes or instances of objects or of surfaces.

The performance of the detection model may furthermore be improved by enhancing at least part of at least one segment representing at least one class of anonymised objects across the scene based on a predetermined change between two or more frames in the video surveillance data. Conventional enhancement techniques such as super-resolution imaging (SR) may be used for that purpose.

The said predetermined change may comprise a change in an appearance or motion of the said at least one object between the said two or more frames and/or a change in a relationship between the said at least one object and at least another object in the said two or more frames. For instance, an object of interest may be detected by the appearance of that object, when that object starts to move and/or when that object interacts with another object. Similarly, an event of interest may be detected by the disappearance of an object, an increase in the velocity of an object, and/or in view of an interaction between two objects.

From the above-mentioned segmentation model experiments it is demonstrated that segmentation models are able to segment objects and surfaces in video surveillance data, which exist in the dataset the segmentation model was trained on. From the results it can also be concluded that segmented data is able to retain information to a degree were HAR and/or AD are possible with an overall small loss in accuracy compared to RGB data. However, as mentioned above, segmenting the video surveillance data and assigning a label mask to every pixel may actually improve performance of the detection systems for some classes or instances of objects or of surfaces.

The present disclosure also provides a video processing apparatus for carrying out the method according to any one of the previous embodiments and features. This video processing apparatus may comprise (or alternatively consist in) the above-mentioned client apparatus. This video processing apparatus comprises at least one processor configured to carry out the said segmentation and detection, and/or any other means for carrying out the said segmentation and detection (e.g. a GPU).

According to the present disclosure, it may be advantageous to store one or more segments of the segmented data. This may be achieved using the above-mentioned recording server. These segments may be stored individually, or for greater convenience, as segmented frames, wherein each segmented frame comprises all segments obtained from a corresponding frame of the video surveillance data. It may be advantageous to store in the recording server at least one frame of segmented data (or a video made of a plurality of such segmented frames) based on which an object or event of interest has been detected. Less relevant frames of segmented data may on the other hand be deleted without being stored in the recording server. Alternatively, all of the segmented data may be stored in the recording server. This allows to carry out additional checks or can help with system testing.

These individual segments and/or segmented frames may later be accessed by an operator or user, for instance by means of a metadata search as described above. To this end, the present disclosure preferably requires determining a user's right to view (as described above) the video surveillance data, the segmented data and/or at least a part thereof, and displaying to the user the video surveillance data, the segmented data and/or at least a part thereof, based on that determination. In extreme cases, only a segment or part thereof may be displayed to the user. It thus becomes possible to hide the original, RGB video surveillance data from a security agent and display to him/her only the segmented data (one or more frames thereof) or a part thereof. On the other end, a super-user e.g. a police officer, may need and be allowed to view the original RGB video surveillance data, in addition to the segmented data.

Alternatively, or additionally, a composite video and/or image of the video surveillance data on which at least one segment is represented, wherein anonymity is provided to an object or surface in the video surveillance data by masking that object or surface with that segment, may be presented to the operator or user. Such a composite video and/or image of the video surveillance data on which at least one segment is represented may be presented to the operator or user without any determination of their rights, considering that the composite video and/or image already achieves a high level of privacy.

While the present disclosure has been described with reference to embodiments, it is to be understood that the disclosure is not limited to the disclosed embodiments. The present disclosure can be implemented in various forms without departing from the principal features of the present disclosure as defined by the claims.

1. A computer implemented method of anonymising video surveillance data of a scene and detecting an object or event of interest in such anonymised video surveillance data, the method comprising:
segmenting frames of video surveillance data of at least one scene into corresponding frames of segmented data using image segmentation, wherein a mask label is assigned to every pixel of each frame of the segmented data based either on a class of objects or of surfaces or on an instance of such a class that pixel belongs to; and
detecting at least one object and/or event of interest based on at least one shape and/or motion in at least one frame of the segmented data.

2. A computer implemented method according to claim 1, wherein segmenting frames of video surveillance data comprises carrying out semantic segmentation of the said video surveillance data.

3. A computer implemented method according to claim 2, wherein segmenting frames of video surveillance data comprises carrying out image segmentation with a first artificial neural network.

4. A computer implemented method according to claim 1, further comprising determining a user's right to view the video surveillance data, the segmented data and/or at least a part thereof, and displaying to the user the video surveillance data, the segmented data and/or at least a part thereof, based on that determination.

5. A computer implemented method according to claim 1, wherein each segmented frame comprises all segments obtained from a corresponding frame of the video surveillance data.

6. A computer implemented method according to claim 1, further comprising acquiring the video surveillance data from at least one physical video camera, and wherein segmenting the video surveillance data comprises segmenting the video surveillance data within the physical video camera.

7. A computer implemented method according to claim 1, wherein the video surveillance data comprises video surveillance data of different scenes from a plurality of physical video cameras.

8. A computer implemented method according to claim 1, further comprising storing in a recording server the said at least one frame of segmented data based on which the said object or event of interest has been detected.

9. A computer implemented method according to claim 1, wherein each segment substantially traces the contour of one or more objects or surfaces represented by that segment.

10. A computer implemented method according to claim 1, wherein each segment is represented as a colour.

11. A computer implemented method according to claim 1, further comprising generating a composite video and/or image of the video surveillance data on which at least one segment is represented, and providing anonymity to an object or surface in the video surveillance data by masking that object or surface with that segment.

12. A computer implemented method according to claim 1, further comprising enhancing at least part of at least one segment based on a predetermined change between two or more frames in the video surveillance data, such that detecting the said at least one object or event of interest is facilitated.

13. A computer implemented method according to claim 12, wherein the said predetermined change comprises a change in an appearance or motion of the said at least one object between the said two or more frames.

14. A computer implemented method according to claim 1, wherein detecting at least one object or event of interest comprises carrying out anomaly detection.

15. A computer implemented method according to claim 1, wherein detecting at least one object or event of interest comprises carrying out detection with a second artificial neural network.

16. A computer implemented method according to claim 1, wherein the objects in the said class of objects are chosen from a group consisting of people and vehicles.

17. A video processing apparatus, comprising at least one processor configured to:
segment frames of video surveillance data of at least one scene into corresponding frames of segmented data using image segmentation, wherein a mask label is assigned to every pixel of each frame of the segmented data based either on a class of objects or of surfaces or on an instance of such a class that pixel belongs to;
and configured to detect at least one object and/or event of interest based on at least one shape and/or motion in at least one frame of the segmented data.

18. A video processing apparatus according to claim 17, wherein the said at least one processor is configured to segment the video surveillance data by carrying out semantic segmentation of the said video surveillance data.

19. A video processing apparatus according to claim 18, wherein detecting at least one object or event of interest comprises carrying out anomaly detection.

20. A video surveillance system comprising a video processing apparatus according to claim 17 and a client apparatus comprising a display, the client apparatus comprising at least one processor configured to determine a user's right to view the video surveillance data, the segmented data and/or at least a part thereof, the at least one processor of the client apparatus being further configured to display to the user the video surveillance data, the segmented data and/or at least a part thereof, based on that determination.
